(19) United States
(12) Patent Application Publication
(10) Pub. No.: US 2010/0302475 A1
(43) Pub. Date: Dec. 2, 2010

(54) BACKLIGHT DISPLAY DEVICE WITH PARTICULAR, UNIFORM OUTER APPEARANCE

(75) Inventors: Henry Beraud, Vincennes (FR); Maryline Thorailler, Omesson sur Marne (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES THERMIQUES, Les Mesnil Saint Denis (FR)

(21) Appl. No.: 12/675,477

(22) PCT Filed: Aug. 28, 2008
(86) PCT No.: PCT/IB08/03993

§ 371 Date: May 12, 2010

(30) Foreign Application Priority Data
Aug. 28, 2007 (FR) 0706033

(51) Int. Cl. G02F 1/1335; G09F 13/08

(52) U.S. Cl. 349/61; 362/97.1

(57) ABSTRACT

The invention relates to a display device (2) for the backlighting (BL) of display members (121a, 121b, 121c, 122) characterised in that it comprises a layer (23) of a light-reflecting material between the display members (121a, 121b, 121c, 122), and a window made of a partially transparent material imparting a particular appearance to said display device (2).

The present invention relates to the general field of backlit display devices. Such devices enable various display elements to be displayed.

Among known display elements, some are supported by a transparent film covered with an opaque coating precisely interrupted at these display elements. In this case, the display elements are advantageously produced by printing with white paint on the transparent film.

Other known display elements, such as a liquid-crystal display screen, may be placed behind the transparent film facing an interruption in the opaque coating.

At the present time, such a transparent film is used in combination with a window made of dark material placed on this transparent film so as to mask the display elements in the absence of backlighting. Thus, the symbols printed on the transparent film, the liquid-crystal display screen or else, when this is the case, various mechanical elements are concealed from view by the user of the vehicle, this being a major advantage from the esthetic standpoint.

These characteristics comply with the current esthetic trend in the automotive field, whereby a “black panel” effect is sought after on automobile control panels. This means in particular that no display element is visible except when the backlighting is applied.

Such display devices may be used in all types of man/machine interface, whether this be on a control panel, a central console or a dashboard, whenever at least one symbol gains in being masked when the backlighting is not turned on.

Such a display device comprises a window made of a material having a low light transmission, for example a transmission coefficient of between 10% and 30%. This window is placed on top of a film interrupted at display elements, advantageously produced by printing with white paint in order to ensure uniformity of vision at all angles at which the display elements may be observed. The term “backlighting” means that the light sent onto the film makes all the symbols visible from outside the display device. In the absence of backlighting, the window masks the film.

However, in very bright environments, for example when sunlight directly illuminates the display device, it is possible to see the display elements.

Specifically, the areas where the display elements are reflect the light, whereas the areas not having display elements absorb the light. Thus, an alternation of areas of different shades of color is visible to the user. This is unsatisfactory from an esthetic standpoint since, in such a case, the display area is easily discernible on a black panel when the backlighting is turned off, this being the opposite of the effect sought.

In addition, the low transmission coefficient requires powerful light sources, which poses not only a problem as regards consumed electric power but also as regards removing the heat generated by the light source(s), thus imposing further constructional constraints.

Thus, the solutions generally adopted for manufacturing a display device with a black external appearance are compromises between dark, or even black, appearance of the display panel when the backlighting is off and visibility of the display elements at a certain distance with a certain amount of light used in backlighting when the latter is on.

These solutions are generally unsatisfactory from an esthetic standpoint or from the point of view of being able to read the display device easily.

One object of the present invention is therefore to alleviate these drawbacks by providing a display device for displaying backlit display elements, which includes a semitransparent layer of light-reflecting material between the display elements and a window made of a partially transparent material giving the display device a particular uniform appearance.

Another object is to obtain a display device enabling less powerful light sources to be used, whilst still maintaining, or even improving, the esthetic appearance.

With such a device, the semitransparent layer of light-reflecting material reflects the external light so that it does not reach a film on which the display elements are supported.

Using a window having an external appearance corresponding to that which it is intended to give the display device permits both the desired external appearance to be obtained and the fact that, where there is no backlighting, the display elements are completely masked and invisible from the outside.

For this purpose, the subject of the invention is a display device for displaying backlit display elements, which includes a semitransparent layer of light-reflecting material between the display elements and a window made of a partially transparent material giving the display device a particular uniform appearance, characterized in that the semitransparent layer of light-reflecting material is supported by an independent film inserted beneath the window and on the display elements.

In this way it is possible to use a window which is less dark than in the case in which the display device is not provided with a reflecting device layer between the window and the transparent film supporting the display elements.

In one embodiment, the light-reflecting material is a metal. The metal used may be chosen from aluminum and chromium.

The semitransparent layer and the independent film are produced, for example, in the form of a metallized sheet of polycarbonate.

The window may be chosen so that the particular uniform appearance is a particular color, for example one having a high level of absorption, such as black. What is then obtained is a display device corresponding to the current trend in providing automobile control panels with an attractive uniform, black appearance, and in which the displays are very discrete.

In one particular embodiment, the display elements are supported by a support film covered with an opaque coating interrupted at these display elements. The use of such a support film is distinguished by being particularly simple to implement.

Specifically, the display elements may then be simply printed using a white paint on the film at the interruptions in the opaque coating. A process for manufacturing this support film by printing characters is conceivable and enables simple production of the device.

It is also possible to provide the display device with a liquid-crystal display screen placed behind the support film facing an interruption in the opaque coating. This is what is generally used when a display device must be able to display both numerical data, which may vary, being then displayed on the liquid-crystal display screen, and symbols which are located at particular positions on the control panel but not capable of changing appearance.

In an advantageous embodiment, the window transmits between 50% and 80% of the received light.

Such light transmission properties, in combination with a layer of reflecting material, make it possible to obtain the desired esthetic appearance.

Advantageously, the semitransparent layer of light-reflecting material transmits between 70% and 80% of the received light.

Other features and advantages of the present invention will become apparent from the description given below with reference to the appended drawings, which in particular illustrate exemplary embodiments thereof, devoid of any limiting character, in which:

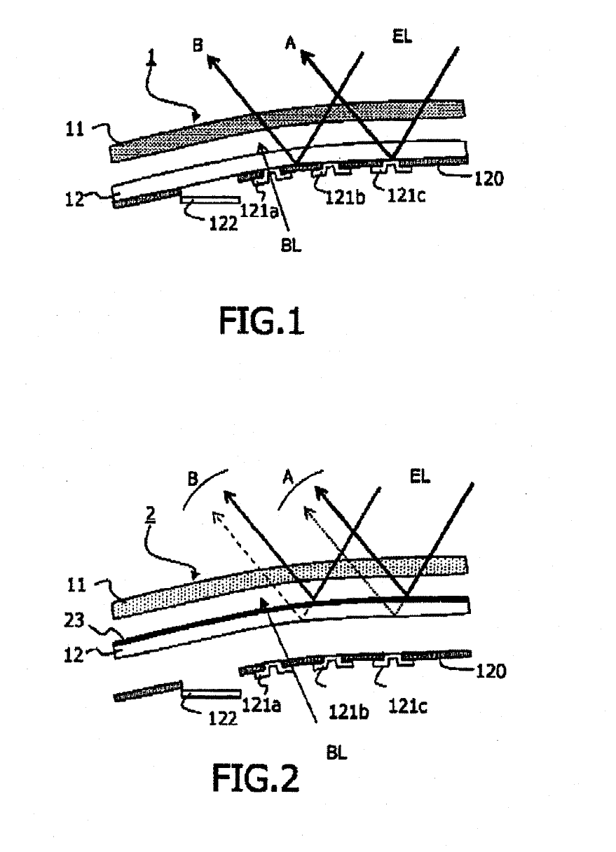

FIG. 1 is a schematic representation of a display device according to the prior art;

FIG. 2 is a schematic representation of a display device according to one embodiment of the invention; and

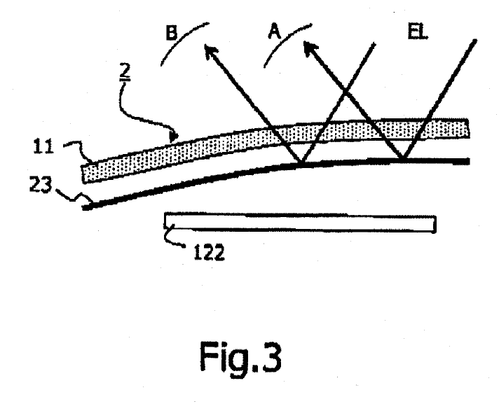

FIG. 3 is a schematic representation of a display device according to another embodiment of the invention.

FIG. 1 describes a display device 1 according to the prior art. This display device 1 includes a window 11 made of a material having a low light transmission, for example a light transmission coefficient of 5%. To the eye, this window 11 therefore appears dark. It may be gray, dark or filled with various color pigments.

The dark window 11 has a black general appearance when the backlighting is turned off. Locally, this window 11 may be painted with an opaque black paint so as to completely conceal the possible elements, for example mechanical or electronic elements, lying behind the window 11, which could be visible from the outside and which never have to be visible from the outside.

The window 11 is placed on top of a partially transparent support film 12 and covered with an opaque coating 120, interrupted at the display elements 121a, 121b, 121c that it is intended to support.

The display elements 121a, 121b, 121c are generally symbols placed at interruptions in the opaque coating 120 and produced by printing with white paint in order to ensure uniformity of vision at all angles at which the display elements may be observed.

It is these elements printed with white paint that, forming the display elements, are directly denoted in FIG. 2 by the references 121a, 121b, 121c.

One particular interruption in the opaque coating 120 is designed to be placed opposite a display element 122, such as for example a liquid-crystal display screen 122. Of course, as an alternative, it is possible to envision, as display element 122, for example VFD (vacuum fluorescent display) screens, a TFT (thin-film transistor) or TFT-LCD (thin-film transistor liquid-crystal display) screen, a variant of liquid-crystal display screens, or LED (light-emitting diode) or OLED (organic light-emitting diode) display screens.

When the backlighting, represented by the arrow BL, is turned on, the light which it directs onto the support film 12 passes through the liquid-crystal display screen and/or the display elements 121a, 121b, 121c, especially made of white paint, which are printed on the film 12 and then through the window 11. The amount of light passing through the window 11 is, for example, 5% of the received light. The total transmission of emitted light is therefore about 5% at the liquid-crystal display screen 122 or printed symbols or display elements 121a, 121b, 121c.

This makes all the symbols 121a, 121b, 121c and/or the liquid-crystal display screen 122 visible from outside the display device 1.

In the absence of backlighting, the black window 11 conceals the support film 12 so that the alternation of opaque coating areas 120 and particular areas of interruption in the opaque coating 120 marking the display elements 121a, 121b, 121c or the liquid-crystal display screen 122 on the support film 12 is not visible from the passenger compartment.

As shown in FIG. 1, the opaque coating areas 120 have a reflection coefficient of 10% and the areas with the display elements 121a, 121b, 121c have a reflection coefficient of 50%.

Thus, for a quantity L of light having passed through the window 11, the perception L_{A} in respect of the areas having the display elements 121a, 121b, 121c is:

L_{A}=0.5 L.

The perception L_{B} in respect of the opaque coating areas 120 is:

L_{B}=0.1 L.

By definition, the contrast is an image-intrinsic property which makes it possible to quantify the capability of distinguishing two separate regions. The contrast is a quantity which must vary from 0, for areas having the same intensity, to 1 for areas having the greatest difference in intensity. If the maximum intensity is denoted by Iₘₐₓ and the minimum intensity by Iₘᵢₙ, the contrast may be defined by:

C=(Iₘₐₓ−Iₘᵢₙ)/(Iₘₐₓ+Iₘᵢₙ).

For the example shown in FIG. 1, a contrast C₁ is then obtained:

C₁=0.666.

Referring now to FIG. 2, this shows a display device according to the invention. This display device 2 possesses the same technical elements as the display device presented in FIG. 1. The references for these technical elements will consequently have the same references as defined in relation to FIG. 1. The display device according to the invention further includes a layer 23 of a semitransparent light-reflecting material.

This layer 23 of reflecting material is supported by an independent film (given the thinness of the layer and of the independent film, both bear the same reference number), or in other words a sheet or film placed here on the external surface of the transparent support film 12. The semitransparent layer 23 and the independent film are produced for example in the form of a metallized sheet of polycarbonate.

In FIG. 2, to reinforce the independent nature of this film with the layer 23, both have been shown at a distance from, on one side, the window 11 and, on the other side, the support film. Of course, this independent film in the form of a sheet may be placed on the support film or be in physical contact therewith.

It will therefore be understood that this layer is therefore supported by a film other than the support film 12, inserted between the window 11 and the support film 12. The layer 23 of reflecting material therefore acts as a mirror when external daylight is reflected on said layer.

Henceforth, it is possible to use a window 11 having a better light transmission while still maintaining a black external appearance. This window 11 will therefore be chosen so as to be less dark than the window chosen in the device of FIG. 1.

Thanks to this higher total transmission coefficient, it is possible to use less powerful light sources for backlighting, which is less expensive, consumes less energy in operation and which makes it possible to reduce the heat generated by the light sources and the problems of getting rid of the heat.

In the embodiment shown in FIG. 2, the opaque coating areas 120 have a reflection coefficient of 10% and the areas having the display elements 121a, 121b, 121c have a reflection coefficient of 50%. Moreover, the support film 12 has a transmission coefficient of 50%. Since the sum of the transmission and reflection coefficients is 100% assuming that no energy is absorbed, the reflection coefficient is 50%.

Thus, for a quantity L of light having passed through the window 11, the perception L_{A} in respect of the areas having the display elements 121a, 121b, 121c is:

L_{A}=0.5 L+0.5×0.5×0.5 L=0.625 L.

The perception L_{B} in respect of the opaque coating areas 120 is:

L_{B}=0.5 L+0.5×0.1×0.5 L=0.525 L.

For the example shown in FIG. 1, a contrast C₂ is then obtained:

C₂=0.087.

When ambient lighting is present and for the same window 11 having a given light transmission coefficient, the contrast between the opaque coating areas 120 and the areas having the display elements 121a, 121b, 121c is 8.25 times higher without the film 12 than a configuration that includes the film 12. It therefore follows that the areas having the display elements 121a, 121b, 121c are more visible in a configuration without a layer 23 than a configuration with a layer 23. Therefore, the general appearance in unlit mode is more uniform for a configuration with a layer 23 as the contrast between the various areas is lower.

As a consequence, the greater the amount of external light, the less the display elements are visible, since more light is reflected. This is therefore very advantageous. The window 11 can therefore transmit up to 80% of the light.

When this light is external light, as shown schematically in FIG. 2 by the arrows EL, this light is uniformly reflected off the semireflecting layer 23, for example a metal coating.

From the outside, the appearance of the display device is therefore uniform to that of the window 11. The display elements 121a, 121b, 121c and the liquid-crystal display screen 122 are not visible through said window.

On the other hand, when the backlighting is turned on, the backlight represented by the arrow BL in FIG. 2 passes through the layer 23 of light-reflecting material. This layer therefore has a transmission coefficient of between 70 and 80%, and only 20 to 30% of the emitted light is reflected by this layer. This light then passes through the window 11 with 50% to 80% of the light power having passed through the metal coating 23. The resulting light transmission is therefore between about 35% and 64%.

To increase the resulting light transmission, a layer of reflecting material capable of transmitting light with a high transmission coefficient, for example up to 80%, is therefore used. In this case, a resulting light transmission of about 64% is obtained.

FIG. 3 differs from the embodiment shown in FIG. 2 by the fact that, on the one hand, the display element 122 is produced in the form of a display screen, for example VFD (vacuum fluorescent display) screens, a TFT (thin-film transistor) or TFT-LCD (thin-film transistor liquid-crystal display) screen, a variant of liquid-crystal display screens, or LED (light-emitting diode) or OLED (organic light-emitting diode) display screens without backlighting and, on the other hand, there is no support film as in the previous embodiment.

In this exemplary embodiment, this layer 23 of reflecting material is supported by an independent film (given the thinness of the layer and of the independent film, both bear the same reference number), or in other words a sheet or film placed here on the external surface of the transparent support film 12. The semitransparent layer 23 and the independent film are for example produced in the form of a metallized sheet of polycarbonate.

This layer 23 and the window 11 have the same transmission properties as those described in the case of the exemplary embodiment shown in FIG. 2.

In this case, thanks to this higher total transmission coefficient, it is possible to operate the display screens with reduced light emission power, which is less expensive and less energy-consuming in operation and which makes it possible, for certain types of display screen, to reduce the heat generated by the light sources and the problems of getting rid of the heat.

Thus, with the invention, the display elements are displayed in substantially the same way as that obtained in the known display devices when the backlighting is turned on but in a substantially different way in external appearance when the backlighting is turned off.

The subject of the present invention as described in relation to the various examples explained in detail above is a display device in which the alternation of the areas having the display elements and the areas not having display elements is not visible. Thus, from an esthetic standpoint, no display element is visible except when the backlighting is applied, thus preserving the desired “black panel” effect.

The present invention is particularly applicable in heating, ventilation and/or air-conditioning units and in particular in the motor vehicle equipment field.

1. A display device for displaying at least one display element, the display device comprising:
a semitransparent layer of light-reflecting material between said at least one display element and a window made of a partially transparent material giving the display device a particular uniform appearance,
wherein the semitransparent layer of light-reflecting material is supported by an independent film inserted beneath the window and on said at least one display element.

2. The device as claimed in claim 1, wherein the device possesses several backlit display elements.

3. The device as claimed in claim 1, wherein the light-reflecting material is a metal.

4. The device as claimed in claim 3, wherein the metal is one selected from a group consisting of aluminum and chromium.

5. The device as claimed in claim 3, wherein the semitransparent layer and the independent film are produced in the form of a metallized sheet of polycarbonate.

6. The device as claimed in claim 1, wherein the particular uniform appearance is a particular color.

7. The device as claimed in claim 6, wherein the particular color is a color having a high level of absorption.

8. The device as claimed in claim 1, wherein the at least one display element is supported by a support film covered with an opaque coating interrupted at the at least one display elements.

9. The device as claimed in claim 8, wherein the at least one display element is printed in white on the support film.

10. The device as claimed in claim 8, wherein the at least one display element is a display screen.

11. The device as claimed in claim 10, wherein the display screen is a liquid-crystal display screen placed behind the support film facing an interruption in the opaque coating.

12. The device as claimed in claim 1, wherein the window transmits between 50% and 80% of the received light.

13. The device as claimed in claim 1, wherein the semitransparent layer of light-reflecting material transmits between 70% and 80% of the received light.
